(19) United States
(12) Patent Application Publication
(10) Pub. No.: US 2005/0051036 A1
(43) Pub. Date: Mar. 10, 2005

(54) Steam cooker and configuration and method for steam cooking

(75) Inventors: Klaus Erdmann, New Bern, NC (US); Bernhard Gotz, Zaisenhausen (DE); Jochen Herbolsheimer, Trostberg (DE); Barbara Ranzenberger, Bretten (DE)

Correspondence Address: LERNER AND GREENBERG, PA, P O BOX 2480, HOLLYWOOD, FL, 33022-2480, US

(73) Assignee: BSH Bosch und Siemens Hausgerate GmbH

(21) Appl. No.: 10/920,887

(22) Filed: Aug. 18, 2004

Related U.S. Application Data
(63) Continuation of application No. PCT/EP03/01310, filed on Feb. 10, 2003.

(30) Foreign Application Priority Data
Feb. 18, 2002 (DE) 102 06 690.6

(51) Int. Cl. F27D 11/00; A47J 37/12

(52) U.S. Cl. 99/415; 219/401; 99/418

(57) ABSTRACT

A method for steam cooking in an oven having a heating device disposed in a bottom area utilizes a cooking container that can be placed in the oven and having a heat-conductive dish element for receiving a liquid supply and a steam tray disposed on the dish element for receiving a product to be cooked. Steam is produced from the liquid supply in the dish element by placing the heating device in the bottom area of the oven so that the steam flows around the product to be cooked on the steam tray to steam cook said product. To such an end, the dish element of the cooking container includes a holding device for disposing the dish element at a distance from the bottom of the oven. Preferably, the dish element divides the oven into two substantially separate spatial regions.

### CROSS-REFERENCE TO RELATED APPLICATION

This application is a continuation, under 35 U.S.C. § 120, of copending international application No. PCT/EP03/01310, filed Feb. 10, 2003, which designated the United States; this application also claims the priority, under 35 U.S.C. § 119, of German patent application No. 102 06 690.6, filed Feb. 18, 2002; the prior applications are herewith incorporated by reference in their entirety.

### BACKGROUND OF THE INVENTION

### FIELD OF THE INVENTION

The method relates to a steam cooker and to a method and configuration for steam cooking. European Patent Application EP 0 566 166 B1 discloses a generic steam cooker for the cooking of food in a specially constructed steam oven. The steam oven has an oven muffle, on the bottom of which a heating device is provided and which additionally possesses a water tank. For steam cooking, a steam cooker, which is configured as a closed cooking vessel and in which the food is disposed on a steam insert, is placed with its lower part, which serves as a water reservoir, onto the heating device of the oven muffle, the lower part being connected to the water tank. By the lower part of the cooking vessel being heated with the aid of the heating device, steam is generated, which, as a result of its buoyancy, rises upward and, at the same time, flows around the steamed food on the steam insert to cook the food. The steam, then, condenses partially on the colder surface of the food or on the top side of the cooking vessel, the condensate dripping back into the lower part. Because the cooking vessel is not completely leak tight, however, a large part of the steam escapes into the oven muffle. One disadvantage of this configuration of the steam cooker is that, for the steam operation, it is necessary to have a specially configured steam oven with an exposed heating device onto which the cooking vessel is placed directly for steam cooking. Furthermore, handling is complicated because the cooking vessel has to be connected manually to the water tank in the steam oven to ensure a sufficient supply of water for the cooking operation.

European Patent EP 045817 B1 discloses a further steam cooker with a closed cooking vessel for the reception of food, in which the cooking vessel is pushed into a heatable oven muffle capable of being closed by an access door and the cooking vessel is, at the same time, connected to a steam generation device disposed outside the oven muffle. The oven muffle, together with the cooking vessel, is heated to a temperature of at least 100° C. in a heating phase. As a result, a condensation of the steam subsequently injected by the steam generation device for steam cooking is prevented. In such a configuration of the steam cooker, too, a special steam oven with an external steam generation device is, again, necessary, to carry out the steam generation operation.

Moreover, German Utility Model GM 77 03 401 describes a steam cooker with a cooking vessel formed from a lower pot and a lid, in which, a steam insert for receiving the food is disposed, and, for steam cooking, externally generated steam is injected into at least one inlet orifice in the lid and is drawn off from at least one condensate orifice in the vessel bottom so that the steam flows positively through the food from the top downward.

German Published, Non-Prosecuted Patent Application DE 37 14 324 A1 discloses, furthermore, a steam cooker for microwave ovens that has a vessel containing a water supply and in which a microwave-impermeable steam insert provided with steam passages is inserted, and has a likewise microwave-impermeable lid. During steam cooking, the water in the vessel of the steam cooker is heated with the aid of the microwaves in the microwave oven, flows through the food on the steam insert, and is, subsequently, discharged into the microwave oven through a pressure outlet lid.

### SUMMARY OF THE INVENTION

It is accordingly an object of the invention to provide a steam cooker and configuration and method for steam cooking that overcome the hereinafore-mentioned disadvantages of the heretofore-known devices and methods of this general type and that make it possible, in a conventional baking oven, to carry out a steam cooking operation that is simple to handle.

With the foregoing and other objects in view, there is provided, in accordance with the invention, a steam cooker for steam cooking food in a baking oven having a bottom region, a bottom, and a heating device disposed in the bottom region, the steam cooker including a cooking vessel removably introduced into the baking oven and having a heat-conducting trough part for receiving a supply of liquid, the trough part having a holding device holding the trough part spaced apart from the bottom of the baking oven and a steam insert disposed on the trough part for receiving the food and, with the heating device, generating steam from the liquid supply that flows around the food on the steam insert.

The steam cooker according to the invention for the steam cooking of food in a conventional baking oven, with a heating device in the bottom region, is distinguished by a heat-conducting trough part for receiving a liquid supply, on which is disposed a steam insert for the reception of food that, to be steam-cooked, has flowing around it steam generated from the liquid supply in the trough part. The trough part of the steam cooker is, in such a case, provided with a holding or spacing device to dispose the trough part so as to be spaced apart from the bottom of the baking oven and, consequently, from the heating device. By virtue of such a configuration, it is possible to carry out the steam cooking operation in a conventional baking oven with a standard heating device under the baking oven bottom because the configuration spaced apart from the baking oven bottom ensures that no heat accumulation occurs at the bottom of the baking oven, which accumulation would arise when the steam cooker is placed thereon directly, which could, then, lead to damage to the baking oven. It may be particularly advantageous if the steam cooker has no feet, but, instead, is held in holding devices provided on the side walls, the trough part being configured such that the baking oven is subdivided substantially into two space regions separate from one another.

The configuration of the trough part for subdividing the cooking space of the baking oven into two space regions substantially separate from one another and disposed one above the other ensures, furthermore, that, during the steam cooking operation that is brought about by the heating device in the baking oven bottom, a temperature drop occurs in the oven muffle between the upper region and the lower region so that the steam that is generated in the trough part and flows around the food condenses in the upper region, in order, then, to be returned into the liquid supply in the trough part. The configuration ensures that there does not have to be any additional water tank or any steam injection in the roasting over because, due to the circulatory process, the liquid supply contained in the trough part is sufficient to conclude the cooking operation. The two space regions obviously do not, in such a case, have to be sealed off hermetically relative to one another.

What has been the applies similarly to the configuration according to the invention for steam cooking with a steam cooker in the manner described above and with a baking oven having a separately switchable underheat heating device that is suitable for the use of the cooking operation according to the invention.

In accordance with another feature of the invention, to achieve better heat transmission in the steam cooker, that side of the trough part that faces the baking oven bottom has a structured and/or dark construction to increase a heat-absorbing surface.

In accordance with a further feature of the invention, for the simplified division of the two space regions in the baking oven, the holding device is configured as two guide rails that are disposed on opposite sides of the trough part and that can be pushed onto corresponding carrying elements formed in the baking oven sidewalls or disposed there. It is, in such a case, preferable, furthermore, that an outwardly angled edge of the trough part serves as guide rails. As a result, a holding device of simple configuration is achieved for the steam cooker. At the same time, as a result, the trough part can also be used, alternatively to the steam cooking operation, for a roasting operation in which the food is, then, disposed directly in the trough part without a liquid supply.

In accordance with an added feature of the invention, the cooking vessel of the steam cooker is configured in two parts with an additional heat-insulating lid that possesses an inclined lid roof. Such a configuration ensures that the steam generated from the liquid supply in the trough part largely condenses on the heat-insulating and, therefore, colder lid, the lid inclination ensuring that the condensate is led back along the cooking vessel wall into the liquid supply quickly and reliably.

In accordance with an additional feature of the invention, there is provided a depression, in which the lid is held securely, is provided peripherally in the edge region of the trough part.

In accordance with yet another feature of the invention, the lid may have at least one steam outlet orifice to make the steam cooking operation in the steam cooker pressureless so that a complicated excess pressure device in the cooking vessel may be dispensed with. The introduction of a minimum quantity of water in the trough of, for example, 500 to 750 ml, is, therefore, sufficient to make it possible to carry out the steam cooking operation reliably. At the end of the steam cooking operation, unconsumed water is left behind in the trough and can be disposed of in a simple way.

In such a case, preferably, orifices in the lid and/or in the trough part serve for steam outlet. The lid is, in such a case, preferably, provided with a hood-shaped lid roof disposed on four glass plates that serve as sidewalls, the glass plates being connected at the corners to battens that are shortened in relation to the height of the glass plates. Such a configuration gives rise to orifices through which steam can emerge between the trough part and the lid.

In accordance with yet a further feature of the invention, the glass side wall plates have a lower edge and a sealing batten is disposed on each lower edge of the side wall plates, the sealing batten having a U-shaped receptacle slipping onto the lower edge and a sealing surface disposed opposite the U-shaped receptacle adapted to lie on the trough part.

In accordance with yet an added feature of the invention, the trough part has a bottom and the steam insert has grips for handling by a user and a perforated plate with feet adapted to stand on the bottom of the trough part.

In accordance with yet an additional feature of the invention, the trough part has a heat-absorbing surface and a side facing the bottom of the baking oven and the side has at least one of a structure and a heat-absorbing color increasing heat absorption of the heat-absorbing surface.

With the objects of the invention in view, in a baking oven having a bottom region, a bottom, and a heating device disposed in the bottom region, there is also provided, a steam cooker for steam cooking food including a cooking vessel removably introduced into the baking oven and having a heat-conducting trough part for receiving a supply of liquid, the trough part having a holding device holding the trough part spaced apart from the bottom of the baking oven and a steam insert disposed on the trough part for receiving the food and, with the heating device, generating steam from the liquid supply that flows around the food on the steam insert.

With the objects of the invention in view, there is also provided a baking oven, including a oven housing having a bottom region with a bottom and a separately switchable underheat heating device, a heating device disposed in the bottom region, and a steam cooker for steam cooking food having a cooking vessel removably introduced into the baking oven and having a heat-conducting trough part for receiving a supply of liquid, the trough part having a holding device holding the trough part spaced apart from the bottom of the baking oven and a steam insert disposed on the trough part for receiving the food and, with the heating device, generating steam from the liquid supply that flows around the food on the steam insert.

According to the invention, the configuration for steam cooking is constructed such that the baking oven has a separately switchable underheat heating device in the bottom region. The use of only underheat during steam cooking ensures an optimum cooking process. Further, a baking oven control may be provided, with a “steam cooking” setting facility, in which, by an appropriate control of the underheat heating device, a desired temperature for the baking oven of 130° to 170° C., preferably, 150° C., can be set. Such a configuration ensures that a temperature of above 100° C. is reached reliably in the trough part spaced apart from the bottom of the baking oven to ensure the evaporation process. It is preferable to operate the baking oven without the steam cooker with a preheating phase of preferably 10 to 15 minutes in the region of the abovementioned desired temperature, to bring about, in the baking oven, a temperature drop in which substantially the desired temperature is established in the bottom region of the baking oven so that, when the steam cooker is pushed in, steam generation and, consequently, the cooking operation commence abruptly.

With the objects of the invention in view, the steam-cooking setting includes a cooking phase with the steam cooker, the cooking phase having a duration dependent upon a food item to be cooked.

In accordance with again another feature of the invention, the steam-cooking setting includes a cooking phase with the steam cooker, the cooking phase having a duration dependent upon a food item to be cooked.

With the objects of the invention in view, there is also provided a method for steaming food in a baking oven having a heating device in a bottom region thereof, the method including the steps of providing a removable steam cooking vessel with a heat-conducting trough part for receiving therein a liquid supply and a steam insert for receiving food therein, the steam insert being disposed on the trough part, providing a liquid in the trough part and food to be steam cooked in the steam insert, introducing the cooking vessel in the baking oven with the trough part spaced apart from a bottom of the baking oven, and steam cooking the food by generating steam flowing around the food on the steam insert from the liquid supply in the trough part with aid of the heating device.

In accordance with a concomitant feature of the invention, for a steam cooking operation, a cooking space of the baking oven is subdivided into two space regions substantially separate from one another.

Other features that are considered as characteristic for the invention are set forth in the appended claims.

Although the invention is illustrated and described herein as embodied in a steam cooker and configuration and method for steam cooking, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

FIG. 1A is an exploded perspective view of a steam cooker according to the invention;

FIG. 1B is a cross-sectional view through a trough part of the cooker of FIG. 1A;

FIG. 1C is a fragmentary, enlarged, cross-sectional view through a sealing batten slipped onto a side part of a lid of the steam cooker of FIG. 1;

FIG. 2A is a front elevational view of a steam cooking configuration according to the invention with the steam cooker of the invention pushed therein; and

FIG. 2B is a cross-sectional, diagrammatic side view and a partially block circuit diagram of an embodiment of the steam cooker according to the invention FIG. 2b illustrating the baking oven with the steam cooker.

### DESCRIPTION OF THE PREFERRED EMBODIMENTS

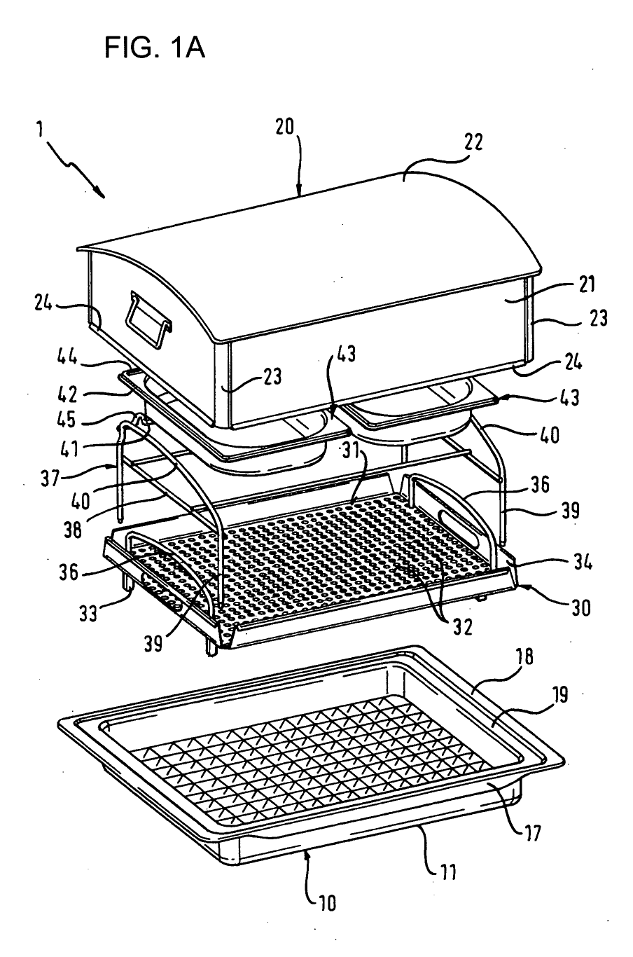

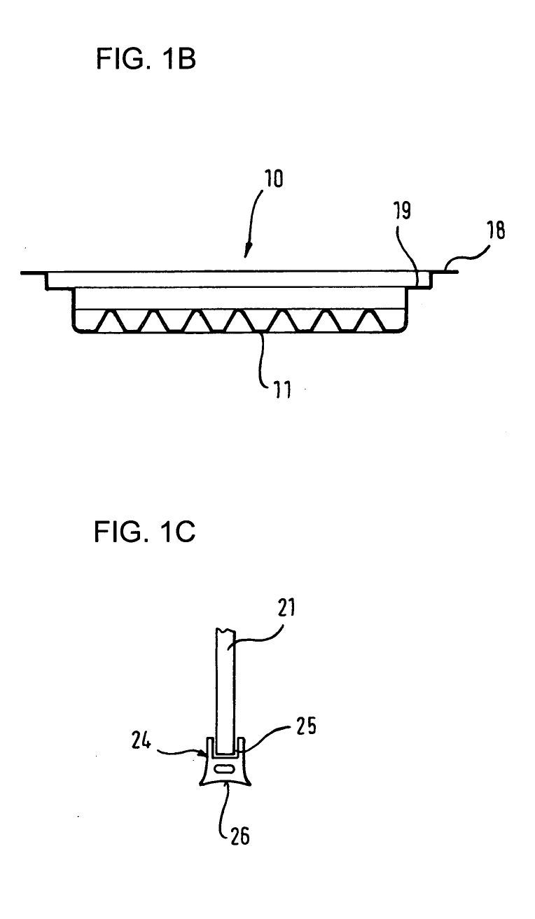

Referring now to the figures of the drawings in detail and first, particularly to FIG. 1 thereof, there is shown a steam cooker has a cooking vessel 1 with a trough part 10 and with a lid 20. The trough part 10 serves for receiving a liquid supply, in particular, water, and, as the cross-section in FIG. 1B shows, has a bottom 11 that has a, preferably, waffled-shaped construction. The waffle-shape achieves an increased bottom surface and, therefore, heat-absorbing surface, thus ensuring that the trough part has improved heat absorption. Alternatively to a waffle structure, there is also the possibility of providing another type of bowed structure in the bottom of the trough part 10 to achieve such an increased heat-absorbing surface. Furthermore, the bottom 11 of the trough part 10 is, preferably, produced from a highly heat-conducting material. As a result, heat absorption is further improved. The bottom 11 of the trough part 10 is, preferably, dark and, thus, acts as a black radiator. As a result, heat absorption is increased.

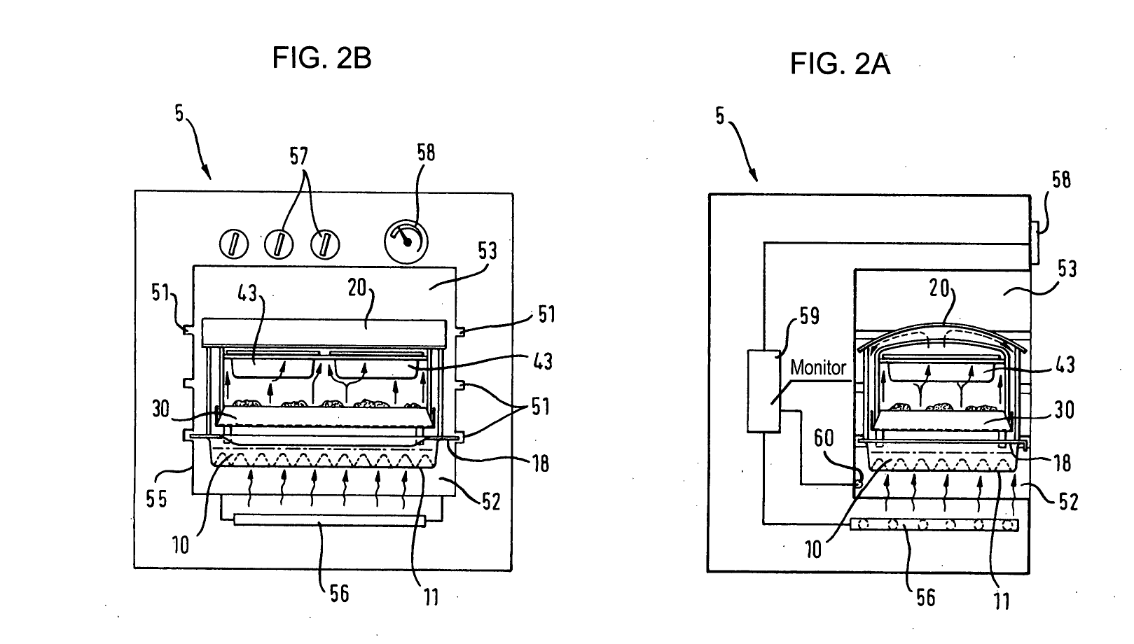

A peripheral edge 18 of the trough part 11 is angled on all sides perpendicularly outward, the edge 18 being configured with two steps so that a depression 19, which serves as a support and sealing surface for the lid 20, is formed all-around in a side facing the cavity in the trough part. The edge 18 is, preferably, configured to be widened on the two narrow sides of the substantially rectangular trough part 11 to serve as holding elements that can be placed or pushed onto corresponding carrying elements in a baking oven. As shown in the embodiment in FIGS. 2A and 2B, these carrying elements may be push-in grooves 51 on a baking oven wall 55. The widened edge 18 of the trough part 10 can be pushed into the grooves 51.

Instead of such push-in grooves 51, however, carrying frames, for example, telescopic pull-outs in the baking oven 5, may also be used for carrying the trough part 10 in its widened edge region 18. Alternatively to the configuration of the widened edge as holding elements for the trough part 10 and, consequently, the cooking vessel 1 of the steam cooker, spacers, for example, in the form of four feet disposed on the bottom 11 of the trough part 10, may also be provided.

As shown in FIG. 1A, furthermore, there is provided on the longitudinal sides of the edge 18 a bent portion 17 that, preferably, extends vertically downward and that serves as a handle so that the cooking vessel can be pulled out of the baking oven in a simple way at the trough part. The overall surface of the trough part 10 of the cooking vessel 1, preferably, corresponds to the bottom surface of the baking oven 5 so that, with the cooking vessel 1 pushed in, the trough part 10 subdivides the baking oven 5 into two space regions 52, 53 substantially separate from one another, as shown in FIGS. 2A and B.

A steam insert 30 spaced apart by feet 33 may be provided in the trough part 10 of the cooking vessel 1. The steam insert 30 is, preferably, manufactured from plastic or high-grade steel and has a horizontal supporting plate 31 that is provided with a matrix-shaped configuration of passage holes 32 through which steam can pass. The food can be disposed on the supporting plate 31. The large continuous surface of the supporting plate 31 makes it possible to cook even large items of food here. The supporting plate 32 is drawn up at its edges 34 to ensure that the food cannot slip off from the supporting plate 32 when the steam insert 30 is being taken out of or introduced into the trough part 10. To ensure that the steam condensing on the steam insert 30 or on the food can flow back into the liquid supply in the trough part 30, the edge 34 is perforated laterally. For the simple handling of the steam insert 30, in particular, the insertion into and removal from the trough part 10, furthermore, bow-shaped grips 36 are provided on the narrow sides. The height of the feet 33 on the supporting plate 31 is coordinated so as to give rise, between the supporting plate 31 and the bottom 11 and trough part 10, to a cavity that makes it possible to receive at least one liter of liquid, this amount being sufficient for the steam cooking of even heavy and bulky food.

A second cooking level can be provided on the steam insert 30 with the aid of a carrying frame 37. The carrying frame 37, in such a case, preferably, has a horizontal framework 38 that is formed from four tubes and that is carried by four vertical tubes 39 disposed on the framework. These tubular feet 39 can be inserted, preferably, into the steam passage holes 32 in the supporting plate 31 of the steam insert 30. The narrow sides of the framework 38 have, provided on them laterally in each case, bow-shaped grips 40 by which the carrying frame 37 can be handled in a simple way. Furthermore, the bow grips 40 are, preferably, connected through a transverse strut 41 that is disposed above the framework and onto which an outwardly angled edge 42 of a cooking vessel 43, which is carried with its bottom by the framework 38 of the frame 37, can be placed. In the embodiment shown, two cooking vessels 43 can be disposed next to one another on the frame 37, a secure hold of these cooking vessels being ensured by two humps 45 into which a clearance 44 disposed on the cooking vessel 41 can engage.

The lid 20 of the cooking vessel 1 is composed of four sidewalls 21 that are, in each case, of a glass plate and on which is disposed a hood-shaped lid roof 42 descending on two sides. The sidewalls 21 of the lid, which are of glass or are, alternatively, manufactured from pressed glass or PSU-like plastic, are connected to one another by battens 23. These battens 23, preferably, manufactured from metal, are configured to be somewhat shorter than the sidewalls 21 so that, with the lid 20 inserted into the depression 19 on the trough part 10, orifices are obtained, through which steam can escape from the cooking vessel 1. These orifices serve for keeping the cooking vessel pressureless during the cooking operation. As a result, a complicated excess pressure valve device may be dispensed with. However, the steam orifices may also be disposed at any other desired point on the lid 20 or in the upper region of the trough part 10.

Furthermore, a sealing batten 24, which leaves the corner battens 23 free, is placed in each case on the lower edge of the sidewalls 21. A cross-section through these sealing battens 24 placed onto the sidewalls 21 of the lid 20 is shown in FIG. 1C. The sealing batten 24 is configured such that it has a U-shaped recess 25 having substantially the width of the sidewall, for slipping onto this sidewall 21, and a lower, preferably slightly concavely shaped plane sealing surface 26 that, with the lid 20 placed on, sits on the depression 19 on the trough part 10 and, due to the deadweight of the lid 20, ensures reliable sealing so that steam outlet orifices remain in the corner batten region. Alternatively, there is also the possibility of manufacturing the lid as a molding, for example, from a transparent plastic, in which case the venting recesses may, then, be incorporated at any desired point.

Apart from the sidewalls 21, the hood-shaped lid roof 22 may also be manufactured from glass, thus, affording a clear view of the food during the steam operation. Alternatively, however, there is also a possibility of manufacturing the lid 20 from another material that, however, should, preferably, be heat insulating in a similar way to glass—in which case, an inspection hole for a view of the food is provided in the sidewall or in the lid, the inspection hole, preferably, being in the form of an eye to provide an increased viewing angle. Alternatively to a hood-shaped lid inclined on two sides, there is also the possibility of constructing the lid in the form of a penthouse roof or with any other desired roof shape in which the lid roof is inclined to divert the condensing steam to the sidewalls.

The cooking operation with the steam cooker illustrated in FIG. 1 is explained below with reference to FIGS. 2A and 2B. For steam cooking, the trough part 10 of the cooking vessel 1 is filled with a liquid supply, liquid quantity amounting to between 500 and 1000 ml. For improved handling, a line marking, indicating the height of the liquid quantity introduced, may be provided on the trough part 10 for such a purpose. The steam insert 30 provided with the food is, then, inserted into the trough part 10 of the cooking vessel 1, and, if appropriate, a second food level is formed by the frame 37 having the cooking vessels 43 that may, likewise, contain food. The lid 20 is, then, placed onto the trough part 10 to close the cooking vessel 1. At the same time, the baking oven is preheated. The baking oven may be a conventional baking oven with a separately switchable underheat heating device 56 disposed under the bottom.

The underheat heating device 56 is, then, set to a desired temperature of between 130° C. and 170° C., preferably, to 150° C., and is preheated for 10 to 15 min. so that a temperature drop is obtained in the baking space, a temperature of approximately 150° C. being obtained in the region of the lowest push-in level in which the trough part 10 is pushed in with its widened edge 18. After the preheating phase, the steam cooker is, then, pushed into the baking oven muffle, the trough part 10 being inserted into the lowermost push-in level and dividing the baking oven into two space regions substantially separate from one another, the space region 52 with the bottom of the trough part 10 and the space region 53 with the lid 20. What is achieved by the preheating phase is that the heat-conducting bottom 11 of the trough part 10 with the liquid supply is heated substantially immediately to 100° C., as a result, evaporation commences immediately. This steam, then, rises automatically and passes through the steam passage holes 32 of the steam insert 30 and flows around the food lying on the latter and the food disposed in the cooking vessels 44 on the second cooking level lying thereabove to steam-cook the food.

The steam, then, condenses partially on the cooler surfaces of the food and drips back into the trough part 10, and the remaining steam rises as far as the lid roof 22 and condenses, here, and is, then, returned substantially along the sidewalls 21 of the lid 20 to the trough part 10. Furthermore, a small part of the steam escapes through the steam orifices in the lid 20 into the upper space part 53 of the baking oven muffle, the steam outlet being such that, during a cooking process with a desired temperature of 130° C. to 170° C., preferably, 150° C., a cooking operation of up to 1.5 hours is possible, without the entire liquid supply evaporating out of the steam cooker and escaping into the baking oven muffle.

The cooking operation, with the steam cooker pushed in the baking oven, is shown in a front view in FIG. 2A and in a lateral cross-section in FIG. 2B. In the version illustrated, an additional setting knob 58 for steam-cooking setting is provided next to the conventional setting knobs 57 for the baking oven. By such a steam-cooking setting, the type of food can, preferably, be preset so that the steam-cooking setting, then, automatically adapts the length of the cooking operation to the food. Alternatively, however, there may also be provision for setting the length of the cooking operation manually by a time clock. Furthermore, a steam-cooking monitoring device 59 may be configured such that it emits an acoustic or optical signal after the end of the preheating operation to indicate to the operator that he is, then, to introduce the steam cooker into the baking oven to initiate the cooking operation.

To monitor the desired temperature, the steam-cooking monitoring device 59 is connected to a temperature sensor 60 located in the baking oven muffle and, preferably, disposed below the lowermost push-in level, to measure the temperature and to set the heating power of the underheat heating device 56 correspondingly. The end of the steam-cooking phase can, then, be indicated to the user again by an acoustic or optical signal from the steam-cooking monitoring device 59. Furthermore, the steam-cooking monitoring device may be configured such that the underheat heating device 56 is, then, switched off automatically.

Furthermore, alternatively to a steam cooking operation, the cooking vessel may also be used for a roasting operation, in which the trough part, then, does not contain a liquid supply. The food can, then, be laid directly onto the trough bottom or, else, onto the steam insert, and the roasting operation can be carried out with or without the lid.

1. A steam cooker for steam cooking food in a baking oven having a bottom region, a bottom, and a heating device disposed in the bottom region, the steam cooker comprising:
a cooking vessel removably introduced into the baking oven and having:
a heat-conducting trough part for receiving a supply of liquid, said trough part having a holding device holding said trough part spaced apart from the bottom of the baking oven; and
a steam insert disposed on said trough part for receiving the food and, with the heating device, generating steam from the liquid supply that flows around the food on said steam insert.

2. The steam cooker according to claim 1, wherein:
the baking oven has a cooking space; and
said trough part subdivides the cooking space into two space regions substantially separate from one another.

3. The steam cooker according to claim 1, wherein:
said trough part has a heat-absorbing surface and a side facing the bottom of the baking oven; and
said side has at least one of a structure and a dark coloring increasing heat absorption of said heat-absorbing surface.

4. The steam cooker according to claim 1, wherein:
the baking oven has sidewalls and carrying elements at least one of formed and disposed on the sidewalls; and
said holding device has two guide rails disposed on opposite sides of said trough part, for reception into corresponding carrying elements.

5. The steam cooker according to claim 4, wherein said trough part has an outwardly angled edge forming said guide rails.

6. The steam cooker according to claim 1, further comprising a heat-insulating lid removably sitting on said trough part and having an inclined lid roof.

7. The steam cooker according to claim 6, wherein:
said trough part has an edge region; and
a depression for receiving said lid is formed peripherally in said edge region.

8. The steam cooker according to claim 6, wherein said lid defines at least one steam outlet orifice.

9. The steam cooker according to claim 8, wherein said lid has:
battens;
a hood-shaped lid roof of glass formed from four glass side wall plates having a height, said glass side wall plates connected to one another at corners of said roof by said battens; and
said battens are shorter than said height of said glass side wall plates to form steam outlet orifices between said trough part and said lid.

10. The steam cooker according to claim 9, wherein:
said glass side wall plates have a lower edge; and
a sealing batten is disposed on each lower edge of said side wall plates, said sealing batten having:
a U-shaped receptacle slipping onto said lower edge; and
a sealing surface disposed opposite said U-shaped receptacle adapted to lie on said trough part.

11. The steam cooker according to claim 1, wherein:
said trough part has a bottom; and
said steam insert has grips for handling by a user and a perforated plate with feet adapted to stand on said bottom of said trough part.

12. The steam cooker according to claim 1, wherein:
said trough part has a heat-absorbing surface and a side facing the bottom of the baking oven; and
said side has at least one of a structure and a heat-absorbing color increasing heat absorption of said heat-absorbing surface.

13. In a baking oven having a bottom region, a bottom, and a heating device disposed in the bottom region, a steam cooker for steam cooking food comprising:
a cooking vessel removably introduced into the baking oven and having:
a heat-conducting trough part for receiving a supply of liquid, said trough part having a holding device holding said trough part spaced apart from the bottom of the baking oven; and
a steam insert disposed on said trough part for receiving the food and, with the heating device, generating steam from the liquid supply that flows around the food on said steam insert.

14. A baking oven, comprising:
a oven housing having a bottom region with:
a bottom; and
a separately switchable underheat heating device;
a heating device disposed in said bottom region; and
a steam cooker for steam cooking food having:
a cooking vessel removably introduced into the baking oven and having:
a heat-conducting trough part for receiving a supply of liquid, said trough part having a holding device holding said trough part spaced apart from the bottom of the baking oven; and
a steam insert disposed on said trough part for receiving the food and, with the heating device, generating steam from the liquid supply that flows around the food on said steam insert.

15. The oven according to claim 14, wherein said housing has a baking oven control with a steam-cooking setting at which a steam-cooking temperature for the baking oven is set between approximately 130° C. and approximately 170° C.

16. The oven according to claim 14, wherein said housing has a baking oven control with a steam-cooking setting at which a steam-cooking temperature for the baking oven is set to approximately 150° C.

17. The oven according to claim 15, wherein said steam-cooking setting includes a preheating phase without said steam cooker, said preheating phase having a duration of between approximately 10 minutes and approximately 15 minutes.

18. The oven according to claim 15, wherein said steam-cooking setting includes a cooking phase with said steam cooker, said cooking phase having a duration dependent upon a food item to be cooked.

19. The oven according to claim 17, wherein said steam-cooking setting includes a cooking phase with said steam cooker, said cooking phase having a duration dependent upon a food item to be cooked.

20. A method for steaming food in a baking oven having a heating device in a bottom region thereof, the method which comprises:
providing a removable steam cooking vessel with:
a heat-conducting trough part for receiving therein a liquid supply; and
a steam insert for receiving food therein, the steam insert being disposed on the trough part;
providing a liquid in the trough part and food to be steam cooked in the steam insert;
introducing the cooking vessel in the baking oven with the trough part spaced apart from a bottom of the baking oven; and
steam cooking the food by generating steam flowing around the food on the steam insert from the liquid supply in the trough part with aid of the heating device.

21. The method according to claim 20, which further comprises subdividing, for a steam cooking operation, a cooking space of the baking oven into two space regions substantially separate from one another.

22. The method according to claim 20, which further comprises carrying out the steam cooking operation at a baking oven temperature of between approximately 130° and approximately 170°.

23. The method according to claim 20, which further comprises carrying out the steam cooking operation at a baking oven temperature of approximately 150°.

24. The method according to claim 21, which further comprises, before the steam cooking operation, carrying out a preheating phase with a duration of between approximately 10 minutes and approximately 15 minutes without the cooking vessel in the baking oven.
